(19) United States
(12) Patent Application Publication
(10) Pub. No.: US 2011/0214973 A1
(43) Pub. Date: Sep. 8, 2011

(54) AUXILIARY DEVICE FOR A WEAPON AND ATTACHMENT THEREOF

(75) Inventors: Kenneth S. Solinsky, Bedford, NH (US); Wallace E. Woodman, III, Merrimack, NH (US); Alan T. Howe, Merrimack, NH (US); Daniel J. Berube, Wilton, NH (US); Timothy R. Loring, Manchester, NH (US)

(73) Assignee: Insight Technology Incorporated, a Delaware corporation

(21) Appl. No.: 12/862,252

(22) Filed: Aug. 24, 2010

Related U.S. Application Data
(63) Continuation of application No. 11/678,383, filed on Feb. 23, 2007, now abandoned.
Application No. 11/678,383 is a continuation-in-part of application No. 11/008,090, filed on Dec. 9, 2004, now abandoned.
Application No. 11/008,090 is a continuation-in-part of application No. 10/408,762, filed on Apr. 7, 2003, now abandoned.
Application No. 10/408,762 is a continuation of application No. 09/706,085, filed on Nov. 3, 2000, now Pat. No. 6,574,901.
Application No. 09/706,085 is a continuation of application No. 09/109,048, filed on Jul. 2, 1998, now Pat. No. 6,185,854.
Application No. 11/678,383 is a continuation-in-part of application No. 11/558,109, filed on Nov. 9, 2006, now Pat. No. 7,493,722.
(60) Provisional application No. 60/737,569, filed on Nov. 17, 2005.

(51) Int. Cl. H01H 19/14

(52) U.S. Cl. 200/336

(57) ABSTRACT

A plurality of actuators allow a gun operator to control the on/off status of an illuminator attached to a weapon in the area forward of the trigger guard. The actuators are spaced to allow them to extend rearwardly on opposite sides of the trigger guard. “Up” turns the light emitter on and keeps it on or allows it to turn on as long as the actuator is actuated, regardless of which side of the trigger guard the actuator is actuated.

### CROSS-REFERENCE TO RELATED APPLICATIONS

This application is a continuation application of and claims priority to U.S. application Ser. No. 11/678,383, filed Feb. 23, 2007, which is a continuation-in-part of and claims priority to U.S. application Ser. No. 11/008,090, filed Dec. 9, 2004, which is a continuation-in-part of and claims priority to U.S. application Ser. No. 10/408,762, filed Apr. 7, 2003, which is a continuation application of U.S. application Ser. No. 09/706,085 filed Nov. 3, 2000, now U.S. Pat. No. 6,574,901, which is a continuation application of Ser. No. 09/109,048, filed Jul. 2, 1998, now U.S. Pat. No. 6,185,854, both entitled “Auxiliary Device for a Weapon and Attachment Thereof”. U.S. application Ser. No. 11/678,383, filed Feb. 23, 2007, is also a continuation-in-part of and claims priority from U.S. application Ser. No. 11/558,109, filed Nov. 9, 2006, which is a non-provisional of U.S. Application Ser. No. 60/737,569, filed Nov. 17, 2005. The entire disclosures of these applications are hereby incorporated by reference in their entirety.

### TECHNICAL FIELD

The invention relates generally to an auxiliary (e.g., illumination) device for a weapon and, more particularly, to attaching an auxiliary device to a weapon.

### BACKGROUND

The need to be able to effectively see a target and aim a weapon in the direction of the target is well recognized. Auxiliary devices to facilitate illuminating a target or aiming a weapon, especially under low light conditions, are known. Examples of known auxiliary devices include scopes, illuminators, lasers, aiming lights and combined illuminator/laser units. For convenience, these (and other) devices are generally referred to herein as auxiliary devices. Attaching auxiliary devices to a weapon typically requires separate brackets or other mechanical components, which may necessitate tools, e.g., screwdrivers, coins, hex wrenches or bullets, for attaching the auxiliary device itself or the mechanical component. Alternatively, attaching and detaching the device or mechanical components to the weapon requires partial disassembly or modification of the weapon. Further, such systems typically require use of two hands to mount the device on the weapon, with both hands performing a function beyond merely gripping the weapon. This requirement presents several disadvantages. For instance, the user may be required to remove the trigger hand from the trigger area of the weapon. Moreover, attachment and detachment of these devices can be time consuming and, in law enforcement and military applications, such time may be critical to the safety of the weapon's operator or others.

As a result of these and other problems with conventional devices, the user typically leaves the auxiliary device mounted on the weapon or performs a time consuming operation to mount the device when needed. These alternatives are undesirable. For example, if the device is left mounted on the weapon, it cannot be used independently of the weapon despite the fact that in some situations, it is desirable to illuminate an area without pointing a weapon toward that area. Also, in the context of handweapons, for example, many holsters do not readily accommodate weapons having auxiliary devices mounted thereon. Thus, it is often difficult to holster or carry a weapon having such a device attached to it. This presents special problems for law enforcement officers and others. Additionally, the user may not want to use the device during daylight hours, but may want to attach the device to a weapon at night. Further, the user may want to be able to readily remove the device when it is no longer needed. Moreover, depending on the configuration of the auxiliary device, the user may need to replace its batteries. Preferably, the user should be able to perform this procedure quickly without the need for tools.

Another problem with conventional auxiliary devices is that the device is often wider than the weapon, or the device protrudes beyond the front end of the weapon. In the case of handweapons, a device mounted below the frame may protrude below the trigger guard. These characteristics often result in subjecting the auxiliary device to greater wear and tear because the auxiliary device often contacts various obstructions in the environment where the weapon is being used. For instance, a device extending beyond the end of a barrel of a weapon may collide with doorways, clothing, tree branches, or other objects, tending to tear the device apart from the weapon and possibly damaging, or rendering inoperable, the device or the weapon itself. Another problem is that an assailant may more easily disarm a user by grabbing an auxiliary device which extends substantially beyond the weapon. The danger of these and other problems occurring are greater at night or when ordinary vision is impaired.

Additionally, many prior auxiliary devices, especially illuminators, are bulky. This characteristic also is undesirable.

U.S. Pat. No. 5,430,967 addresses some of these issues for an auxiliary device for a weapon. The device described therein is provided with a clamping mechanism for attaching an auxiliary apparatus to a weapon having a frame. The clamping mechanism has projections which are biased by a flexible member toward corresponding recessed portions formed in the frame of the weapon. A retaining member is also provided. The retaining member may be moved to between an open and a closed position. While the '967 Patent overcomes some of the problems traditionally associated with the attachment of an auxiliary device to a weapon, it too leaves room for improvement.

For example, the existence of a flexible biasing mechanism results in the auxiliary device being somewhat flexibly attached to the weapon. This flexible attachment is not ideal in some circumstances, for example, for use with auxiliary devices requiring precise boresight alignment. Also, the attachment mechanism is relatively bulky, causing the auxiliary device to be relatively wider, resulting in an increase in the size of the device in at least one dimension. Moreover, the engagement of portions of the auxiliary device with the corresponding portions of the weapon is limited by the degree of flexibility of the flexible mechanism. Furthermore, the spring-loaded mechanism also limits the biasing force holding the auxiliary device to a weapon. As a result, this attachment approach may be successful on weapons, such as handweapons, which have relatively modest recoil forces, but may be somewhat less successful on other weapons, such as shotguns, where the greater recoil forces may cause the auxiliary device to dislodge from the weapon.

While lights and other devices primarily have been mounted to weapons, many weapons are not specifically designed to facilitate this. As a result, special brackets and other mounting devices often need to be used. Some weapons have mounting racks, but various drawbacks exist even with these types of devices. In many cases, it is difficult to mount a device to the weapon and/or complex mechanical structures are necessary.

Gun owners may own two or more weapons and the distance from the front of the trigger guard to the transverse slot located along the lower surface of the dust cover may be different for each weapon. This difference in dimension may cause an auxiliary device not to fit on to the weapon because the back end of the auxiliary device contacts the front surface of the trigger guard before a spring-biased mechanism can engage in the transverse slot. Alternatively, the difference in dimension may cause the auxiliary device to unnecessarily extend past the end of the weapon. Auxiliary device manufacturers have typically produced distinct auxiliary devices that are designed for a particular weapon. Gun owners, however, want a single auxiliary device that can be easily mounted to any of their weapons. An alternative to having multiple auxiliary devices is a single auxiliary device with multiple spring-biased mechanisms that can be swapped in when needed. This requires the owner to store a second part and adds to the manufactured cost.

Rail dimensions differ from manufacturer to manufacturer. This can cause an auxiliary device to fit nicely on some weapons and either be too tight or too loose on another weapon.

Other problems and drawbacks with prior approaches exist.

### SUMMARY OF THE INVENTION

One object of the invention is to overcome these and other drawbacks of known devices.

Another object of the invention is to provide a weapon and auxiliary device system that includes complementary mounting members on the weapon and on the auxiliary device to enable the auxiliary device to be easily and securely attached to the weapon, for example, by relative sliding movement.

Another object of the invention is to provide a weapon and auxiliary device system that includes complementary mounting members on the weapon and on the auxiliary device to enable the auxiliary device to be easily and securely attached to the weapon, for example, by relative sliding movement to a predetermined position, and which further includes a mechanism to fix the auxiliary device in the predetermined position.

Another object of the present invention is to provide an auxiliary device such as an illuminator or aiming light, or combination thereof, with a mechanism for attaching the device to a weapon and particularly a handweapon, such that the actual attachment or removal can be accomplished by a user with one hand, while the second hand is free to grip the weapon.

Another object of the invention is to provide a mechanism for attaching an auxiliary device to a weapon such that the device will maintain or better maintain boresight alignment even after the shocks of repeated weapon fire recoils.

Another object of the invention is to provide a mechanism for mounting an auxiliary device to a weapon without temporary or permanent disassembly or removal of any parts from the weapon to which the device is attached.

Another object of the invention is to reduce or minimize the size of an auxiliary device, for example, by providing an auxiliary device which may be attached to the frame of a weapon such that when the device is attached to the weapon, protrusion of the device beyond the overall dimensions of the weapon is reduced or minimized. Preferably, the width of the auxiliary device does not extend beyond the overall width of the weapon to any appreciable degree. Also, the auxiliary device has minimal or no protrusion beyond the front end of the weapon.

Another object of the invention is to provide a battery operated auxiliary device in which the batteries can be easily and readily replaced and such replacement can be performed without tools.

Another object of the invention is to provide a weapon comprising a frame to which an auxiliary device can be easily attached to and removed from the weapon by a user with one hand, while the second hand is free to grip the weapon (without tools) and when attached will hold boresight alignment to a high degree of precision.

These and other objects may be carried out according to various embodiments of the invention. According to one embodiment, the invention comprises a weapon and auxiliary device system that facilitates attachment of the auxiliary device to the weapon and removal therefrom. Preferably the auxiliary device may be attached to the weapon by relative sliding movement therebetween, to guide the auxiliary device to a predetermined position. According to one aspect of the invention, the system preferably further includes a mechanism for maintaining the auxiliary device in the predetermined position, for example, by providing a mechanism that automatically fixes the position once the predetermined position is reached. One advantage of this combination is that, once mounted, undesired movement of the auxiliary device relative to the weapon (e.g., due to recoil shock caused by firing the weapon) can be reduced or eliminated. Another advantage is that the auxiliary device can be easily mounted to or removed from the weapon with single-handed operation without tools. Various aspects of the invention relate to the system. Other aspects may be used alone on a weapon or an auxiliary device.

According to one embodiment, the auxiliary device comprises a housing with mounting members extending therefrom. The mounting members preferably, but not necessarily, are complimentarily-shaped with respect to mounting members of the weapon to which the auxiliary device is to be attached. Preferably, the mounting members are designed to provide a first positioning mechanism, where one is a male member and the other is a female member, spaced and oriented such that the auxiliary device may be mounted to the weapon by relative sliding movement between the weapon and auxiliary device to a predetermined position.

According to another aspect of the invention, the weapon and auxiliary device are provided with a second positioning mechanism. In one embodiment, the second positioning mechanism includes a male portion and a female portion. For example, a spring-loaded bar at the top of the auxiliary device may project for engagement into a transverse slot in the bottom of the weapon frame to prevent the auxiliary device from sliding forward or aft, e.g., when the weapon fires. Alternatively, the second positioning mechanism may include an opening on the weapon frame and a complementary projection on the auxiliary device that is engagable with the opening. Other alternatives exist. For example, the weapon alone may have a latch that engages a portion of the auxiliary device when in a predetermined position.

In any of the embodiments the male portion of the second positioning mechanism may include a biasing mechanism, e.g., a spring-biased mechanism, whereby the user manipulates a latch, button or other release mechanism which, under the influence of a spring or other biasing device, is typically maintained in a normally locked or a normally unlocked position. The spring-loaded projection may be contoured such that the auxiliary device can slide onto the weapon without having to manually depress the projection.

To remove the auxiliary device from the weapon, the spring biasing the second positioning mechanism is manually depressed (or otherwise moved) to allow disengagement of the second positioning mechanisms. Then, the auxiliary device may be slid forward for removal from the weapon.

In another embodiment, the grooves or tongues along the side of the weapon frame are not parallel to the frame and may or may not be parallel to each other. For example, the grooves can be located at an incline or angle with respect to the axis of the barrel of the weapon. In another embodiment, the grooves or tongues may be replaced by other suitable complementary engaging surfaces which allow relative sliding motion between the frame of the weapon and the auxiliary device.

In another embodiment, the grooves or tongues along the side of the weapon frame may be replaced with a rail along the bottom of the frame. A transverse slot or hole may be located in the bottom or side(s) of the rail.

In another embodiment, the male portion (e.g., bar or pin) is not spring-loaded. Rather it is mechanically moved to engage the female portion (e.g., slot or hole) in the bottom of the weapon frame and is mechanically lowered or allowed by gravity to fall to disengage the slot or hole when removal of the auxiliary device from the weapon is desired.

According to one embodiment of the invention, a weapon frame is provided with a pair of elongated side rails of a predetermined geometry formed along opposite sides of the frame extending from forward of a trigger guard to about the forward most end of the barrel. An auxiliary device comprising a housing is provided with structural members that extend from or form part of the housing, and have a predetermined geometry to enable the auxiliary device to mate with the rails of the weapon for attachment thereto. These structures cooperate to locate and align the auxiliary device at a predetermined position with respect to the weapon.

According to another aspect of the invention, the predetermined position of the auxiliary device with respect to the weapon may be fixed by providing a second positioning mechanism on one or both of the weapon or auxiliary device to prevent or reduce mounted undesired movement of the auxiliary device relative to the weapon (e.g., due to recoil shock caused by firing the weapon). This mechanism may include a female portion and a male portion. For example the female portion may comprise a recess, transverse slot, circular opening or other female portion, formed in the bottom of the frame forward of the trigger guard. The male portion may comprise a pin, bar elongate projection or other male portion on the auxiliary device. The male portion may be biased to at least partially enter the female portion in the weapon frame once the predetermined position is reached. Preferably, the second positioning mechanism may lock the auxiliary device to the weapon frame without manipulation of that mechanism by the person attaching the auxiliary device to the weapon. Alternatively, the second positioning mechanism may tend to prevent the movement of the auxiliary device, without locking it to the weapon frame. In this case, the second positioning mechanism could include, for example, a detent ball mechanism or other structure.

According, to one embodiment, the auxiliary device is slid onto the frame of a weapon (in a first direction) via the first positioning mechanism and a second positioning mechanism is actuated to fix the position of the auxiliary device relative to the frame in at least the first direction. The second positioning mechanism preferably includes one component that moves in a direction perpendicular to the first direction.

Preferably at least a portion of the second positioning mechanism comprises a spring-loaded projection that projects from either the auxiliary device or the weapon, into a portion of the other, without having to manually depress the projection. This facilitates the ease with which an auxiliary device can be reliably secured to a weapon. To remove the auxiliary device from the weapon, the spring biasing the second positioning mechanism is manually depressed (or otherwise moved) to allow disengagement of the second positioning mechanism. Then, the auxiliary device may be slid forward for removal from the weapon.

According to one embodiment, an illumination device has a spring-biased mechanism movable between a first position in which the spring-biased mechanism is engageable in a transverse slot disposed on the frame of a weapon to resist movement along a longitudinal axis and a second position in which the spring-biased mechanism is spaced from the transverse slot so as not to resist movement of the illumination device along the longitudinal axis.

According to another embodiment, the auxiliary device has a spring-biased mechanism that enables it to be secured to weapons having different dimensions from the front of the trigger guard to the transverse slot along the lower surface of the dust cover.

According to another embodiment, the auxiliary device has a rotatable member that can accommodate a range of rail dimensions and has a locking mechanism for preventing rotation of the rotatable member.

According to another embodiment there is provided an illuminator for use with a weapon having a trigger guard. The illuminator may include a housing having a longitudinal axis, the housing at least partially enclosing a battery and supporting a first and a second movable actuator mechanically coupled to the housing. The first actuator moveable in a first general direction, independent of the second actuator, to cause a light emitter coupleable to the battery to turn on and stay on and moveable in a second general direction, independent of the second actuator, to cause the light emitter to turn on as long as the actuator is actuated, and the second actuator moveable in the first general direction, independent of the first actuator, to cause the light emitter to turn on and stay on and moveable in the second general direction, independent of the first actuator, to cause the light emitter to stay on as long as the actuator is actuated.

Other objects, features, and advantages of the embodiments will become readily apparent when the detailed description of the embodiment is read in conjunction with the drawing figures.

### BRIEF DESCRIPTION OF THE DRAWINGS

FIG. 1 is a perspective view of an auxiliary device mounted to a weapon, consistent with one embodiment of the invention.

FIG. 2 is a front elevational view of the auxiliary device mounted to the weapon as in FIG. 1.

FIG. 3A is a perspective view of a weapon consistent with another embodiment of the invention.

FIG. 3B is a perspective view of a weapon consistent with a further embodiment of the invention.

FIG. 4 is a perspective view of the auxiliary device of FIG. 1 consistent with yet another embodiment of the present invention.

FIG. 5 is a cross-sectional view of the auxiliary device attached to the weapon frame showing the latching mechanism as being upwardly biased by a leaf spring.

FIG. 6 is a cross-sectional view of the auxiliary device's transverse bar being upwardly biased by a biasing mechanism consistent with a further embodiment.

FIG. 7 shows a further attachment technique used to mount a scope or other auxiliary device above the weapon.

FIG. 8 is a cross-sectional view of an auxiliary device with a longitudinally positionable spring-biased mechanism consistent with a further embodiment of the invention.

FIG. 9 is an exploded perspective view of an auxiliary device consistent with a further embodiment of the invention.

FIG. 10 is an exploded perspective view of an auxiliary device consistent with a further embodiment of the invention.

FIG. 10A is a perspective view of a portion of an alternative spring-biased mechanism for use in the auxiliary device of FIG. 10.

FIG. 11A is a perspective view of an auxiliary device spaced from a rail and in a “locked” position consistent with yet a further embodiment of the invention.

FIG. 11B is an exploded perspective view of the auxiliary device of FIG. 11A.

FIG. 11C is a perspective view of the auxiliary device of FIG. 11A in a “released” position.

FIG. 12A is a side view of a positioning mechanism consistent with yet a further embodiment of the invention adjacent a MIL-STD-1913 rail.

FIG. 12B is a side view of the positioning mechanism of FIG. 12A adjacent a “Weaver” rail.

FIG. 13 is a perspective view of a tactical illuminator consistent with one embodiment of the invention mounted to a weapon.

FIG. 14 is a rear perspective view of the tactical illuminator of FIG. 13.

FIG. 15 is an exploded perspective view of a tail cap assembly of the tactical illuminator of FIG. 13.

FIG. 16 is a rear view of a tap cap assembly consistent with a second embodiment of the invention.

### DETAILED DESCRIPTION OF THE EMBODIMENTS

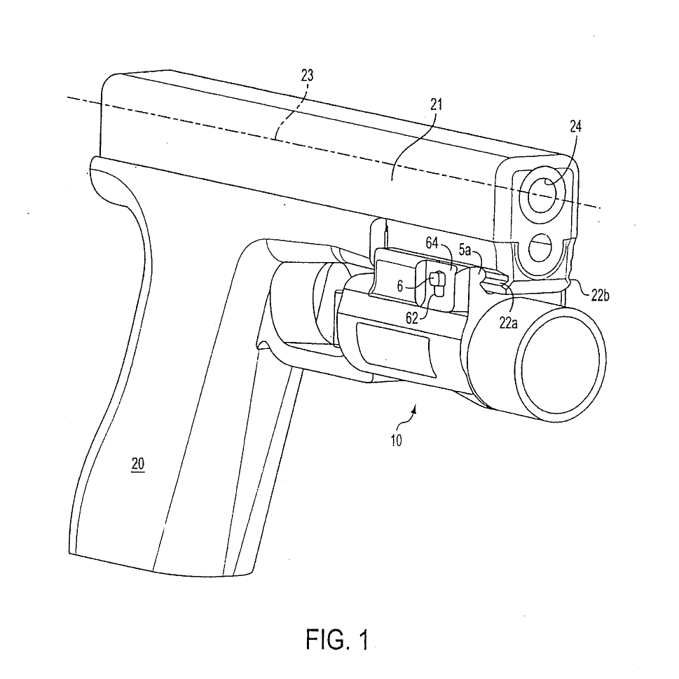

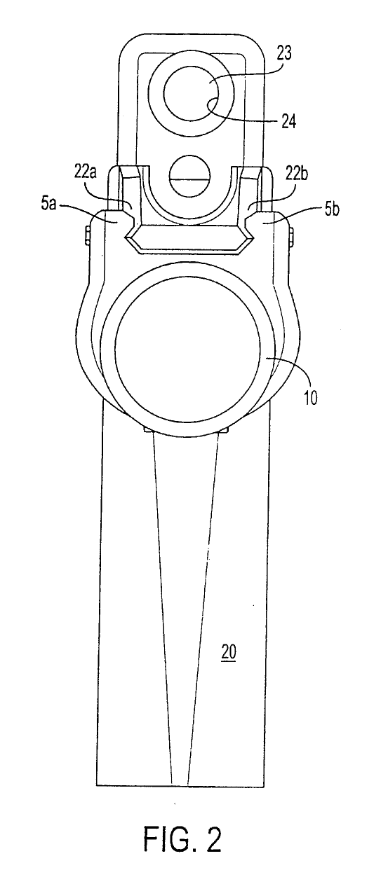

With reference to FIGS. 1, 2 and 4, there is depicted an auxiliary device 10 mounted to a pistol-type weapon 20. For convenience, the description that follows refers to the auxiliary device as an illuminator, which is a device generally used to cast light upon a target area or a portion thereof. This should not be construed as a limitation of the invention, however, as this embodiment is for illustrative purposes only. As those skilled in the art will appreciate from this disclosure, the novel features described herein may readily be applied to other auxiliary devices and weapons. Moreover, the figures are provided as examples only. It is to be understood that the invention is not limited to the particulars depicted in the figures.

According to one embodiment, weapon 20 comprises a weapon frame 21 with rails or grooves 22a and 22b, located in and extending along at least a portion of the weapon frame 21, preferably parallel with an axis 23 of the barrel 24. Preferably, the rails extend from about a trigger guard 30, to substantially the forward most end of frame 21. The weapon frame 21 also preferably includes a slot (or other recess), for example, an elongate transverse slot 25, aligned substantially perpendicular to the rails 22a, 22b. The slot 25 is preferably located between trigger guard 30 and the forward most portion of the frame 21.

Auxiliary device 10, as shown in FIGS. 1, 2 and 4, also preferably comprises a housing and structural members extending therefrom, e.g., rigid elongated projections 5a and 5b, extending along at least a portion of the auxiliary device 10. Preferably, the rigid elongated projections comprise tongues 5a, 5b designed to be compatible with grooves 22a, 22b of weapon 20. For example, the longitudinal tongues 5a, 5b may be spaced and sized such that they fit snugly within the grooves 22a, 22b, but are capable of being slid therealong. Together, the rails 22a, 22b and projections 5a, 5b cooperate to function as a first positioning mechanism.

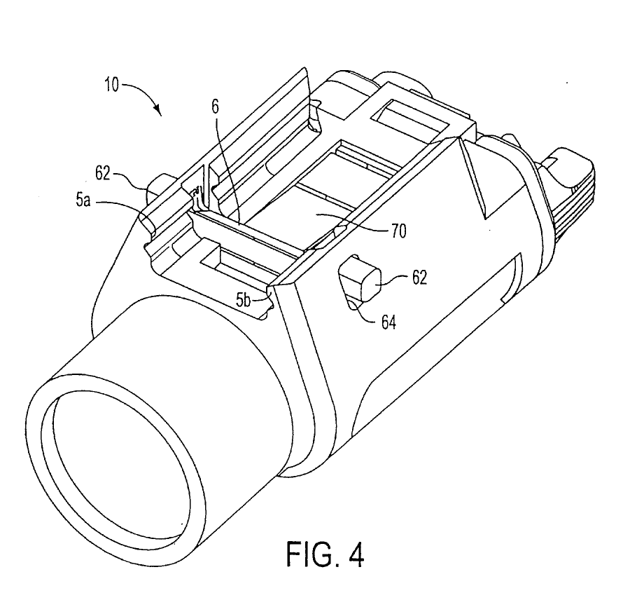

The auxiliary device 10 preferably further comprises a projection, e.g., spring-loaded elongated bar 6 (FIGS. 1 and 4). The spring-loaded bar 6 is illustrated as being oriented substantially orthogonal to the longitudinal tongues 5a, 5b, but other orientations are possible. Preferably, spring-loaded bar 6 has a geometry that is complimentary to elongate transverse slot 25. For example, spring-loaded bar 6 may extend substantially across the width of auxiliary device 10. Spring-loaded bar 6 preferably has one or more ends 62 protruding through an opening 64 formed in a portion of auxiliary device 10 (e.g., an upright extension projecting from the housing). A spring 70 (FIG. 4) or other biasing mechanism preferably biases bar 6 upwardly. When the auxiliary device is being slid relative to the weapon, a portion of the weapon may overcome the bias force of the spring, until the auxiliary device is at a predetermined position with respect to the weapon, for example when the spring-loaded bar 6 is positioned in alignment with slot 25, whereupon, the spring causes the bar 6 to project into slot 25 to fix the auxiliary device in the predetermined position relative to the weapon. The engagement of bar 6 and slot 25 forms a second positioning mechanism and secures auxiliary device 10 onto frame 20 to prevent inadvertent removal or misalignment of auxiliary device 10 due to external influences such as recoil.

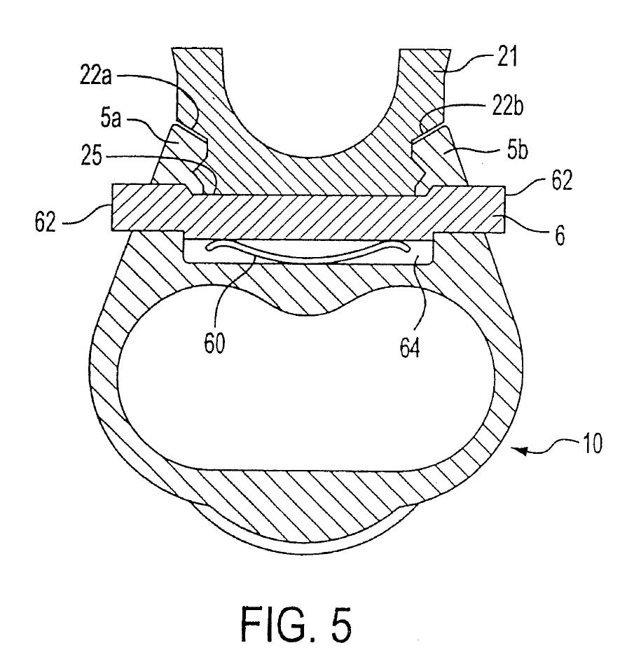

FIG. 5 depicts a cross-sectional view of an auxiliary device mounted to a weapon. In this embodiment, the first positioning mechanism includes, e.g., tongues 5a, 5b formed on the auxiliary device 10 in complementary engagement with corresponding grooves 22a, 22b formed on the weapon frame 21. Both the tongues and grooves are rigid structural elements to provide a rigid attachment between the auxiliary device 10 and the weapon frame 21. A second positioning mechanism is depicted in FIG. 5, including a transverse bar 6 which, under the biasing force of leaf-spring 60, is inserted into a transverse slot 25 formed on the weapon frame 21. The leaf-spring 60 is preferably securely positioned within an opening 64 formed in the top of the auxiliary device 10, and held in place in a suitable manner. The leaf-spring 60 normally biases bar 6 upwards and away from recess 64. When removing the auxiliary device 10 from the weapon frame 21, the user grasps opposing ends 62 of bar 6 and pulls downwardly to cause the partial compression of leaf-spring 60 and move bar 6 out of engagement with the groove 25.

In the embodiment of FIGS. 1-4, the auxiliary device 10 is mounted on the weapon by aligning the tongues (5a and 5b) with the weapon's grooves (22a and 22b) and sliding the auxiliary device 10 on the weapon 20 to a predetermined position. The transverse bar 6 and slot 25 are located such that when the auxiliary device 10 is at the predetermined position, the bar 6 is aligned with transverse slot 25, such that the bar 6 projects into slot 25 by spring pressure or in other convenient ways (e.g., manually, under the influence of gravity or other mechanisms).

The mating of longitudinal tongues 5a, 5b and grooves 22a, 22b provides alignment of the auxiliary device 10 with the weapon barrel 24 and stability in the horizontal and vertical directions. Additionally, the tongues and grooves constrain the auxiliary device 10 in roll, pitch and yaw relative to the weapon. The second positioning mechanism (e.g., engagement of the transverse bar 6 and slot 25) prevents the auxiliary device 10 from sliding forward or aft during use and particularly during weapon fire due to weapon recoil.

According to another embodiment, male portions (e.g., longitudinal tongues 5a, 5b) may be located on the weapon frame and the female portion (e.g., longitudinal grooves 22a, 22b) may be located on the auxiliary device 10. The geometry of the portions making up the first and second positioning mechanism need not be exactly as disclosed. Various other geometries can be used to accomplish the above-identified objects of the invention.

For example, transverse slot 25 and the transverse bar 6 can be replaced by any other engaging devices position fixers, and/or position fixer receptacles, which tend to prevent relative movement of the auxiliary device 10 with respect to the weapon frame. For instance, a recessed counterbore may be formed in the weapon frame and a pin provided in the auxiliary device 10 such that the pin engages the counterbore when the auxiliary device 10 is installed on the weapon. A spring biased latch may project downwardly from the front portion of the weapon to lock over an edge portion of the auxiliary device, once in a predetermined position, to prevent relative movement. For example, such a latch may fix the position of the auxiliary device between the latch and the trigger guard. In this way, only the weapon needs to be provided with a second positioning mechanism. Other alternatives can be used.

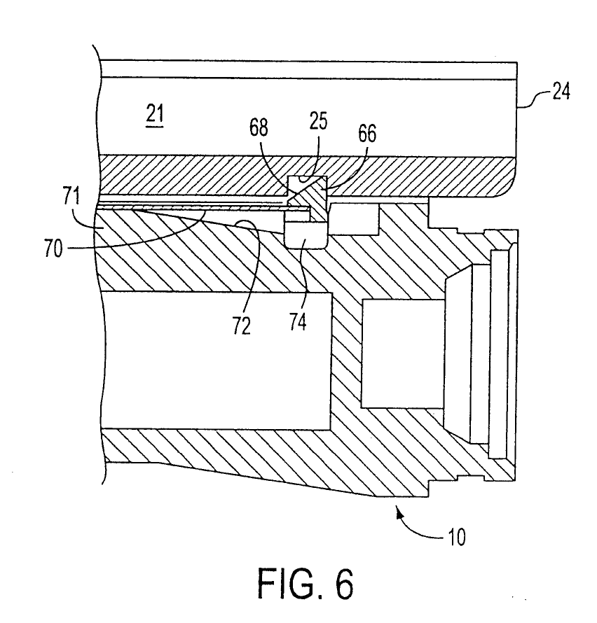

FIG. 6 depicts a side cross-sectional view of another embodiment of the second positioning mechanism. In this embodiment, the weapon frame 21 has, as in the other depicted embodiment, a transverse slot 25 extending at least partially across the bottom of the weapon frame 21. In this alternative embodiment, the secondary complementary engaging mechanism formed on the auxiliary device 10 comprises a latching mechanism 66 which, under the influence of cantilevered spring 70, is upwardly biased into complementary engagement with transverse slot 25. Cantilevered spring 70 includes first and second ends, only one of which, 71, is attached to the auxiliary device 10.

The latching mechanism 66 preferably has at least one end of which is accessible by the weapon operator and may be manually manipulated to overcome the biasing force of cantilevered spring 70. When removing the auxiliary device 10 from the weapon, the user pulls the transverse bar 66 downwardly to overcome the influence of cantilevered spring 70. Cantilevered spring 70 then tends to come into contact with tapered surface 72, at which time transverse bar 66 is freed from slot 25 and the auxiliary device 10 may be slid forwardly and removed from the weapon.

Another aspect of the embodiments of FIGS. 4 and 6 is that the latching mechanism 66 may be formed with an inclined surface 68 at the rear end thereof. The inclined surface 68 facilitates the installation of the auxiliary device on the weapon. Specifically, when the first positioning mechanisms of the auxiliary device 10 and the weapon 20 are initially engaged, and the auxiliary device 10 is slid further onto the weapon, the inclined surface 68 is sized to contact the front end of the weapon. Under further sliding action of the auxiliary device 10, the front end of the weapon slides upwardly along inclined surface 68, causing latching mechanism 66 to overcome the biasing force of cantilevered spring 70 and to enter a recess 74 formed in the auxiliary device 10. Then, upon further sliding action, the latching mechanism 66 is eventually aligned with transverse slot 25, at which time the cantilevered spring 70 causes latching mechanism 66 to rise and lock within transverse slot 25. This (and other techniques for) automatic retraction as the auxiliary device 10 is slid onto the weapon simplifies installation, as it eliminates the need to manually retract the transverse bar 6 as the auxiliary device 10 is being installed. This automatic retraction of the transverse bar 6 can also be accomplished by contouring the leading edge of the weapon frame instead of or in addition to contouring the latching mechanism 66, and by other techniques.

As will be readily appreciated by those of ordinary skill in the art, the mechanisms for attaching the auxiliary device to the frame of the weapon may take different configurations. In a generic form, the auxiliary device is attached to the weapon frame using a first positioning mechanism and a second positioning mechanism. The first positioning mechanism preferably comprise complementary engaging surfaces on the auxiliary device and weapon frame. In a specific embodiment disclosed above, these complementary engaging features comprise longitudinal tongues 5a, 5b on the auxiliary device and complementary grooves 22a, 22b on the weapon frame 21. Other complementary engaging surfaces on the auxiliary device 10 and weapon frame 21 are readily contemplated by the embodiments of the invention. For example, the relative positioning of the tongues and grooves may be reversed such that the weapon frame 21 is formed with tongues, whereas the auxiliary device 10 is formed with complementary grooves. The first positioning mechanism may comprise other suitable complementary engaging mechanisms.

The second positioning mechanism preferably comprises a device which, under normal conditions, sufficiently retains the auxiliary device in a predetermined position relative to the weapon frame. The second positioning mechanism is preferably designed to secure the auxiliary device against movement when the weapon is subjected to recoil forces and other jarring influences which may be expected to be encountered in use and in the field. The second positioning mechanism in the embodiments has been described with respect to a biased transverse bar 6 which engages with an elongate slot 25 formed in the weapon frame. The second positioning mechanism of this particular embodiment acts to prevent the auxiliary device from movement during use. However, other second positioning mechanisms are within the scope of the invention, including spring biased bars or pins or other structures that engage a feature of the weapon from the side or sides or from below, detent mechanisms, latching mechanisms, locking mechanisms and other suitable mechanisms which releasably secure two relatively sliding parts.

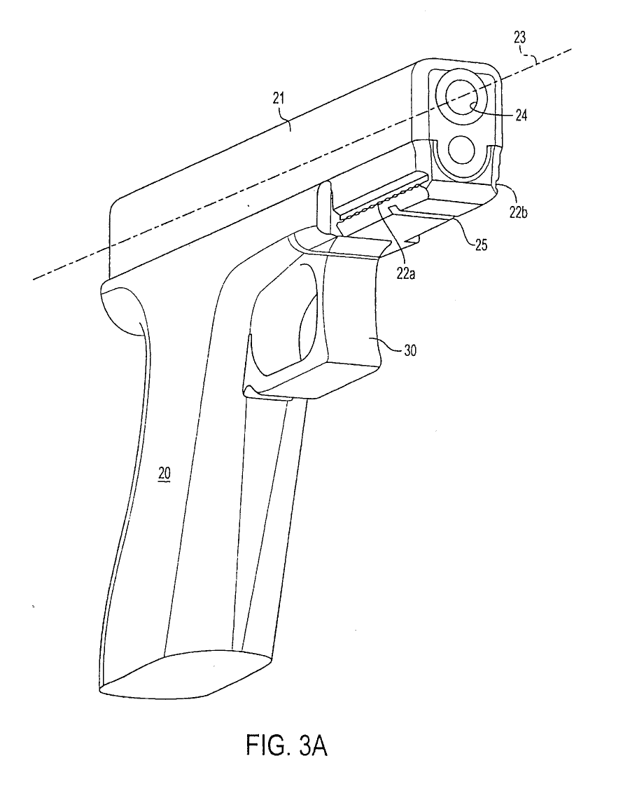

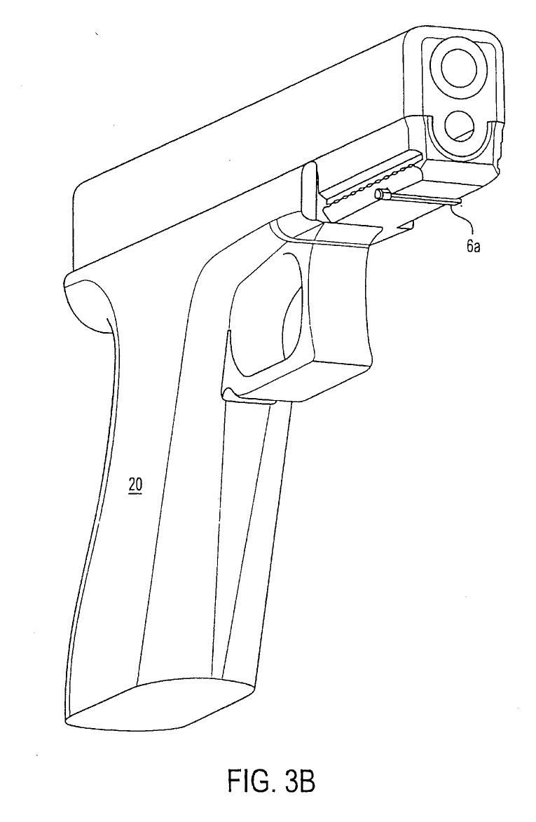

For example, the second positioning mechanism may include the weapon barrel being formed with a recessed counter-bore into which a corresponding biased member, e.g., a ball bearing or a post, formed on the auxiliary device may be inserted. As drawn in FIG. 3B, the second positioning mechanism may optionally be formed from a spring-biased retractable bar 64, post, or ball bearing or other structure integrally formed on the weapon frame which engages a portion of auxiliary device 10, for example, but without limitation, a correspondingly shaped recess formed in the auxiliary device 10 or another portion of the auxiliary device 10. In each of the foregoing and other embodiments, depending on the application, the second positioning mechanism may be designed to lock or otherwise secure the auxiliary device with respect to the weapon frame or alternatively may, such as in the case of a detent mechanism, simply act to deter, but not completely prevent, relative movement between the auxiliary device and the weapon frame under abnormal conditions. For example, a detent could be of sufficient retention capability to resist relative movement due to weapon recoil forces but not be so strong as to prevent deliberate removal of the auxiliary device from the weapon, without first “un-locking” it.

Another aspect of the invention relates to the mounting members, e.g., grooves 22a, 22b, formed along the weapon frame. Preferably, the grooves extend from a point substantially at the trigger guard to the front of the weapon. These grooves 22a, 22b or other mounting members extend along the weapon frame to securely hold and retain the auxiliary device with respect to the weapon and facilitate locating the auxiliary device thereon. This further allows the secure fastening of the auxiliary device to the weapon frame without the use of spring hinges or other such devices which could result in the inadvertent dislocation of the auxiliary device from the weapon frame. The complementary mounting members comprising the first positioning mechanism thus form a rigid and secure mechanism for mounting the auxiliary device to the weapon frame.

In various embodiments depicted, grooves 22a, 22b are depicted as extending substantially parallel to the axis 23 of barrel 24. The invention, however, is not so limited. For instance, grooves 22a, 22b may be positioned at an incline with respect to the longitudinal axis 23 of barrel 24. Alternatively, grooves 22a, 22b may be replaced other suitable engaging surfaces which allow relative sliding motion between the weapon frame 21 and the auxiliary device 10.

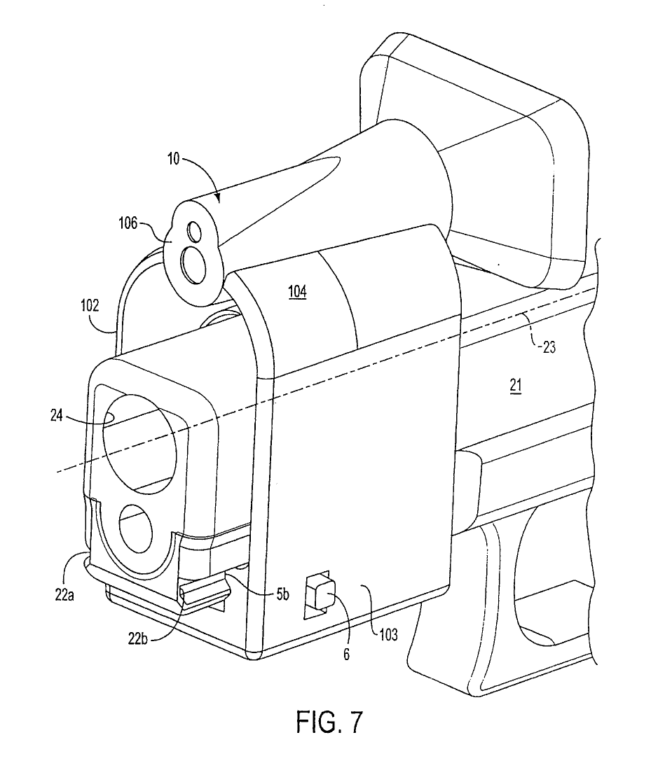

FIG. 7 depicts another embodiment of the invention. In FIG. 7, an auxiliary device 10 is positioned above the weapon frame 21. The auxiliary device 10 preferably includes bar 6 (or other second positioning mechanism) which is adapted for complementary engagement with a corresponding portion of weapon 21, e.g., transverse slot 25 formed at the bottom of the weapon frame 21. Weapon frame 21 preferably includes a first positioning mechanism, e.g., rails or grooves 22a, 22b, located in and extending along at least a portion of the weapon frame 21, preferably parallel with an axis 23 of the weapon frame 21. The auxiliary device 10 of the embodiment of FIG. 7 includes a hollow frame having first and second sides 102, 103 connected by an upper section 104 to a housing for the auxiliary device. An aiming light or other illuminating device 106 may be positioned in or on the housing and preferably is boresighted with the longitudinal axis 23 of the barrel 24.

Though the embodiment of FIG. 7 has been depicted in connection with a hollow arched housing through which the weapon frame 21 penetrates, other configurations for locating the auxiliary device 10 so that the aiming light or other illuminating device 106 is positioned above the weapon frame 21 are possible. For example, the weapon frame 21 could be formed with a pair of longitudinally extending tongues on opposite sides of barrel 24. Likewise, in such an alternative embodiment, a transverse slot or other second positioning mechanism 25 could be formed on top of the weapon frame 21 or on top of the barrel. In any event, no matter the configuration of the second positioning mechanism, preferably, the auxiliary device 10 preferably has a first positioning mechanism (according to various embodiments discussed herein or other positioning mechanisms) such that the auxiliary device 10 is engageable to mount on the weapon frame 21. The precise positioning and configuration of the positioning mechanisms can vary.

The leaf-spring 60 of the embodiment of FIG. 5 and the cantilevered spring 70 in the embodiment of FIG. 6 are but two of many possible biasing mechanisms that may be used in the embodiments of the invention. In addition to the springs for upwardly biasing the bar 6, other mechanical arrangements or combinations thereof, such as alternative forms of springs, wedges, screws or cams, which could cause the bar or other structural member to engage the slot 25 in the weapon, are within the scope of the invention.

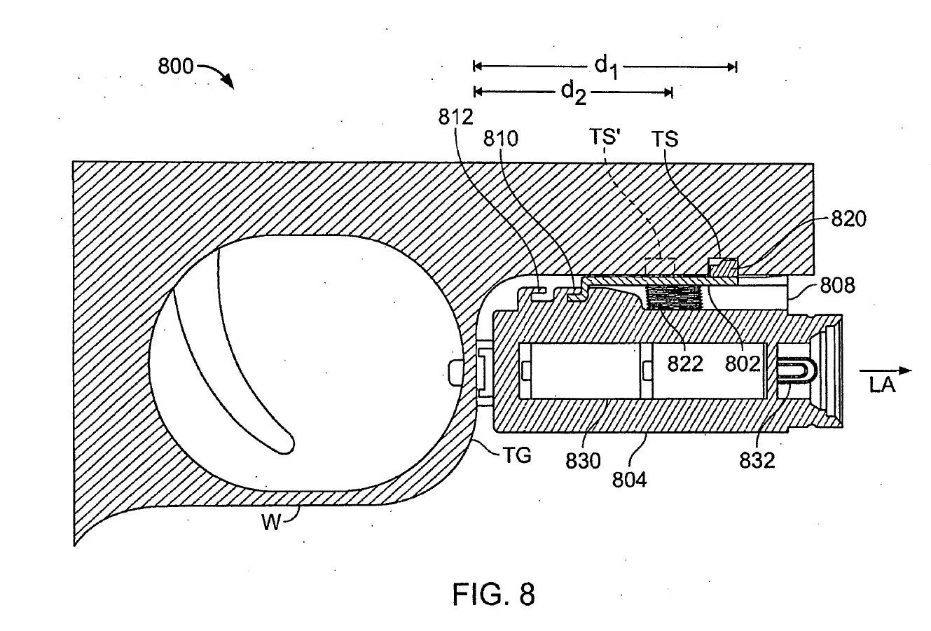

As noted in the Background, the distance from the front surface of the trigger guard to the transverse slot located along the lower surface of the dust cover of a pistol may differ from one weapon to the next. FIG. 8 is a cross-sectional view of an auxiliary device 800 with a longitudinally positionable spring-biased mechanism 802 consistent with a further embodiment of the invention. The auxiliary device 800 may be mounted to a first weapon W having a distance d₁ from the front of the trigger guard TG to the leading edge of a transverse slot TS. Alternatively, the auxiliary device 800 may be mounted to a second weapon having a distance d₂ from the front of the trigger guard TG to the leading edge of a transverse slot TS' (shown in hidden lines).

The auxiliary device 800 includes a housing 804 which may have structural members 808 that extend upward from a side of the housing 804 and extend longitudinally along at least a portion of the housing. The structural members 808 may have grooves and/or tongues extending along at least a portion of the auxiliary device 800 that cooperate with rails on the weapon. The housing 804 may house one or more batteries 830 and a source of illumination 832.

A spring biased mechanism may include a spring biased ball bearing or post, a retractable bar, or other structure which engages the transverse slot TS, TS' on the weapon. In each of the foregoing and other embodiments, depending on the application, the spring-biased mechanism may be designed to lock or otherwise secure the auxiliary device with respect to the weapon frame or alternatively may, such as in the case of a detent mechanism, simply act to deter, but not completely prevent, relative movement between the auxiliary device and the weapon frame under abnormal conditions. For example, a detent could be of sufficient retention capability to resist relative movement due to weapon recoil forces but not be so strong as to prevent deliberate removal of the auxiliary device from the weapon, without first “un-locking” it.

However, other second positioning mechanisms are within the scope of the invention, including spring biased bars or pins or other structures that engage a feature of the weapon from the side or sides or from below, detent mechanisms, latching mechanisms, locking mechanisms and other suitable mechanisms which releasably secure two relatively sliding parts.

The spring-biased mechanism 802 may be secured in two or more positions along a top surface of the housing 804 and may be biased in a direction normal to the top surface of the housing 804. By repositioning the spring-biased mechanism 802 along the longitudinal axis LA of the weapon W the user can easily mount the auxiliary device 800 to weapons having differing dimensions from the front surface of the trigger guard TG to the transverse slot TS. The spring-biased mechanism 802 may be capable of being coupled to a first fixturing mechanism 810 for locating the spring-biased mechanism 802 in a first position along the longitudinal axis LA and may be capable of being coupled to a second fixturing mechanism 812 for locating the spring-biased mechanism in a second position along the longitudinal axis LA. The fixturing mechanisms may include, but are not limited to, a slot, opening, pin, or suitable fastener. The first fixturing mechanism 810 may be spaced from the second fixturing mechanism 812 by a distance (d₁−d₂). The spring-biased mechanism 802 may be metallic, for example, spring steel, plastic, or a combination of metal and plastic. Alternatively, the spring biased-mechanism may be rigid and may be biased by a spring 822, for example a compression or leaf spring.

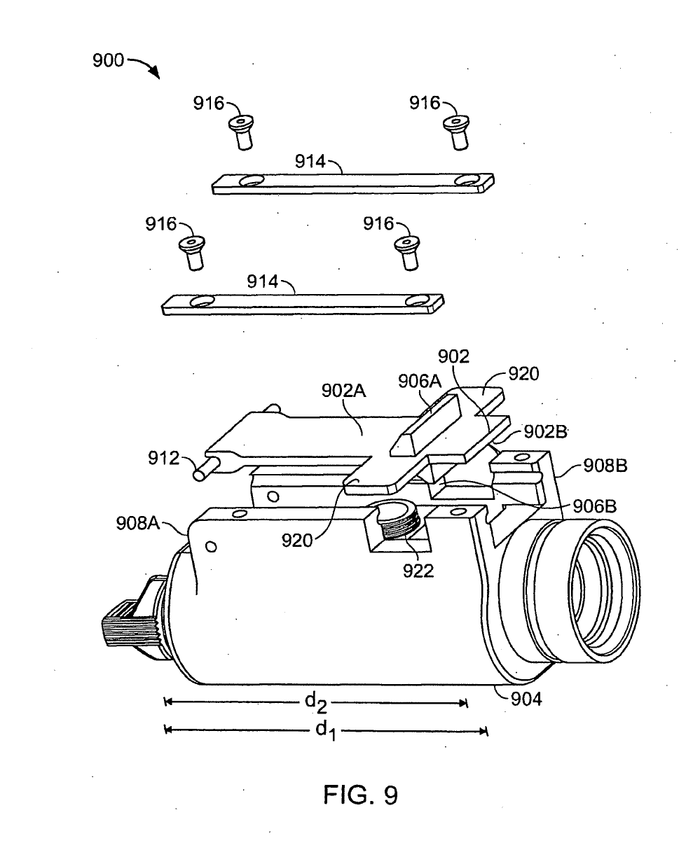

FIG. 9 is an exploded perspective view of an auxiliary device 900 consistent with a further embodiment of the invention. The auxiliary device 900 may have a spring-biased mechanism 902 disposed along a top surface of a housing 904 and may be biased in a direction normal to the top surface of the housing 904. The housing 904 may house a battery and a source of illumination. The housing 904 may have a first structural member 908A and a second structural member 908B that extend upward from a side of the housing and extending longitudinally along at least a portion of the housing. The structural members 908A, 908B may have grooves and/or tongues that cooperate with rails on the weapon.

The spring-biased mechanism 902 may have a first side 902A having a first protuberance 906A spaced a first distance d₁ from a first end of the auxiliary device 900 and a second side 902B having a second protuberance 906B spaced a second distance d₂ from the first end of the auxiliary device 900. The protuberances 906A, 906B may be sized to fit in a transverse slot TS, TS' respectively along the lower surface of the dust cover of a weapon. The width and profile of the protuberances 906A, 906B may be the same or may be different. The spring-biased mechanism 902 may be biased by a spring 922, here a coiled spring. In other embodiments, the spring can be in the form of a compression, leaf, or cantilever spring. One end of the spring-biased mechanism may be captured by and rotatable about a pin 912 coupled to the housing 904 and may be retained by one or more plates 914 and fasteners 916. The spring-biased mechanism 902 may include one or more end portions 920 for assisting in the removal of the auxiliary device 900 from the weapon. The end portions 920 may extend beyond at least one of the first structural member 908A and the second structural member 908B.

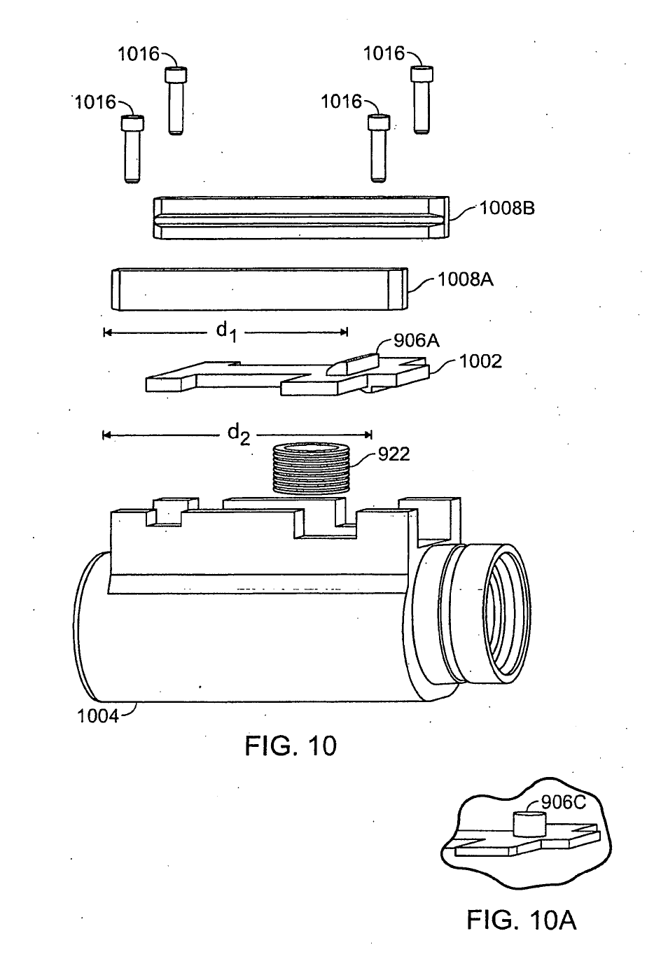

Alternatively, as shown in FIG. 10, the first end of a spring-biased mechanism 1002 may be sandwiched between the housing 1004 and removable first and second structural members 1008A, 1008B. The first and second structural members 1008A, 1008B may be retained by one or more fasteners 1016.

Referring to FIG. 10A, in an alternative embodiment, the first protuberance extending from the first side 902A of spring-biased mechanism 902 may be as shown here in the form of a pin 906C. Alternatively, the first protuberance may be in the form of a bar elongate projection or other male portion extending from the spring-biased mechanism. Similarly, the second protuberance extending from the second side 902B of spring-biased mechanism 902 may also be in the form of a pin 906C or other male portion protuberance.

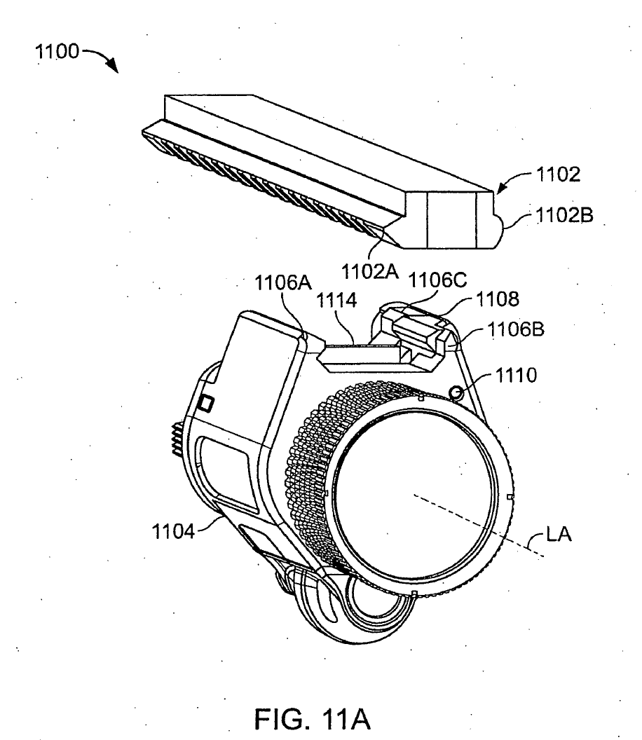

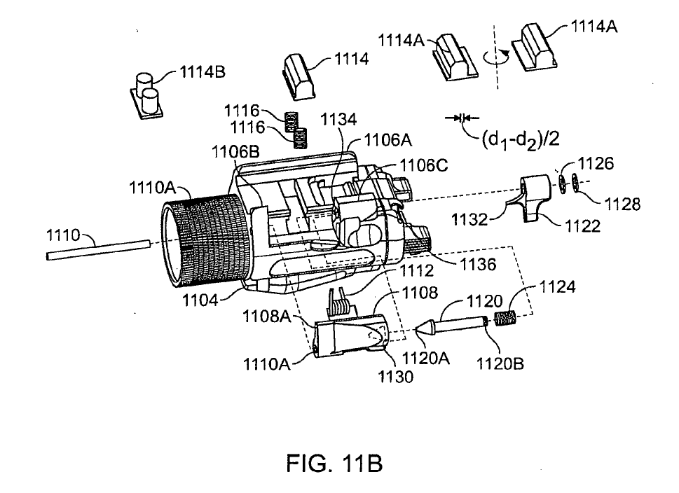

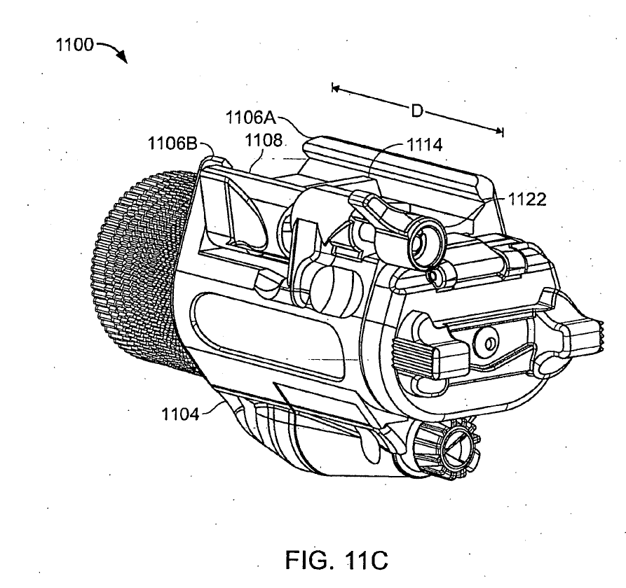

Referring to FIG. 11A and FIG. 11B, a rail 1102 and the auxiliary device 1100 may be positioned above, below (as shown) or to the side of a barrel of a weapon. The rail 1102 may extend along at least a portion of a longitudinal axis of a weapon, for example a handgun or a long gun. The profile of the rail 1102 may be consistent with MIL-STD-1913 (as shown), the Weaver profile and include a pair of generally parallel grooves, for example grooves 22A, 22B shown in FIG. 1, or other dovetail profiles. The dimensions of the rail 1102 may differ from manufacturer to manufacturer and may have mechanical tolerances that need to be overcome for a single auxiliary device to be securable to a variety of weapons. The rail may be an integral or removable part of the weapon.

Auxiliary device 1100 includes a housing 1104 which may house a power source, for example, one or more batteries, and a source of illumination, for example an incandescent filament or an LED. The housing 1104 may be molded or machined and have a first structural member 1106A that extends upward from a first side of the housing and extends along at least a portion of a length of the first side of the housing 1104. The first structural member 1106A may extend generally parallel with a longitudinal axis (LA) of the auxiliary device 1100 for engaging cooperating rails on the weapon. When installed, the longitudinal axis of the auxiliary device 1100 may be parallel with the longitudinal axis of the weapon. The housing 1104 may have a second structural member 1106B and a third structural member 1106C. The structural members 1106A, 1106B, 1106C may be fixed so as not to move relative to the housing 1104.

Coupled to the housing 1104 or the second structural member 1106B and the third structural member 1106C may be a rotatable member 1108 for engaging the rail 1102 on the weapon. The rotatable member 1108 may rotate about the longitudinal axis of the auxiliary device 1100 and may be secured, for example, with a pin or suitable fastener 1110 positioned within holes 1110A extending through housing 1104 or structural member 1106B and rotatable member 1108. The rotatable member 1108 may extend along at least a portion of a length of the second side of the housing 1104 and be substantially parallel to the first structural member 1106.

The rotatable member 1108 may be movable from a first “locked” position (see FIG. 11A) in which the auxiliary device 1100 may be secured to the weapon and a second position (see FIG. 11C) in which the auxiliary device 1100 may be attached to or detached from the weapon.

For example, referring to FIG. 11B, a first biasing member 1112, here a spring, may be coupled to the housing 1104 and the rotatable member 1108 for urging a lip portion 1108A of the rotatable member 1108 to rotate towards the first structural member 1106A. The first biasing member 1112 may be a torsion spring or other mechanism for urging the rotatable member 1108 to rotate. In the first position, the first structural member 1106A and the rotatable member 1108 clamp the rail 1102 from the sides to prevent movement of the auxiliary device relative to the weapon. In the second position, the rotatable member 1108 may be rotated away from the first structural member 1106A to allow the auxiliary device to be coupled to the rail 1102.

A positioning mechanism 1114 may be coupled to the housing 1104 to assist in preventing movement of the auxiliary device along the longitudinal axis of the rail 1102, for example during weapon shock. The positioning mechanism 1114 may be biased by one or more springs 1116 to move the positioning mechanism 1114 in a direction normal to the top surface of the housing for engagement into a cooperating cross slot on the weapon. The positioning mechanism 1114 will be discussed in more detail below. Alternatively, the positioning mechanism may be fixed to or part of the housing 1104.

Rotational positioning of the rotatable member 1108 may be restricted by a locking member 1120. The locking member 1120 may have an axis aligned with the longitudinal axis of the auxiliary device 1100 and have a tapered first end 1120A. The tapered end 1120A of locking member 1120 may be configured to cooperate with a tapered opening 1130 in the rotatable member 1108. Alternatively, the rotatable member 1108 may have a surface that cooperates with the first tapered end 1120A. The tapered end 1120A may be at an angle of less than 45 degrees with the longitudinal axis, for example, 5-30 degrees. A second end 1120B of the locking member 1120 may be coupled to a lever 1122 having a contoured surface 1132. The third structural member 1106C may include an opening 1134. The opening 1134 may include a first portion sized sufficiently large to permit the second end 1120B of the locking member 1120 to move longitudinally, but sufficiently small to stop the tapered end 1120A from passing through the opening and a second end sized sufficiently to permit the tapered end 1120A hide therein. The locking member 1120 may slide or may be guided along a spiral path as it moves longitudinally. A biasing member 1124, a washer 1126, and a retainer 1128 may be assembled to urge the lever 1122 towards the third structural member 1106C.

As the lever 1122 is rotated upward (as shown in FIG. 11C), the contoured surface 1132 of the lever 1122 may slide along a contoured surface 1136 on the third structural member 1106C and draw the tapered end 1120A of the locking member 1120 rearwardly away from the opening 1130. Alternatively, the lever may rotate about a vertical or other axis without departing from the invention. The biasing member 1124 may urge the surface of the tapered end 1120A of the locking member 1120 into contact with the surface of the opening 1130 and resist rotation of the rotatable member 1108.

With the tapered end 1120A of the locking member 1120 at least partially withdrawn from the opening 1130 in the rotatable member 1108, the rotatable member 1108 can rotate. To secure the auxiliary device 1100 to the rail 1102, the installer may rotate the lever 1122 upward withdrawing the locking member 1120 from the opening 1130. The auxiliary device may then be positioned along the longitudinal axis of the rail 1102 with the positioning mechanism 1114 aligned with a transverse slot located on the rail 1102. The installer may align the first structural member 1106A with an edge 1102A of the rail 1102 and then rotate the auxiliary device 1100 onto the opposing edge 1102B. As the auxiliary device 1100 is rotated onto the rail 1102, the biasing force of the first biasing member 1112 may be overcome, thereby allowing the lip portion 1108A to rotate outward and around the edge 1102B of the rail 1102. The first biasing member may urge the lip portion 1108A of the rotatable member 1108 to remain in contact with the rail 1102. The lever 1122 may then be rotated downward urging the locking member 1120 into the opening 1130 and the surface of the tapered end 1120A into contact with the inside surface of the opening 130 in the rotatable member 1108, thus preventing rotation of rotatable member 1108. The rotatable member 1108 may be locked into contact with rails in a variety of rotational positions by the locking member 1120. The user may rotate the lever upward to remove the auxiliary device 1100 form the weapon.

In an alternative embodiment, positioning mechanism 1114 with a transverse bar may be removed and replaced with a positioning mechanism 1114B with one or more post or pins. Alternatively, the pin(s) may be fixed to the housing or individually biased relative to the housing.

As noted in the Background, the distance from the front surface of the trigger guard to a transverse slot located along the lower surface of the dust cover of a pistol may differ from one weapon to the next. An asymmetrical positioning mechanism 1114A may be inserted in the housing 1104 (in place of positioning mechanism 1114) perpendicular to the longitudinal axis in either a first orientation or a second orientation (rotated 180 degrees about a vertical axis) depending on the desired distance D (see FIG. 11C) from the front surface of the positioning mechanism to the rear of the auxiliary device. The centerline of the top portion of the positioning mechanism 1114A may be offset from the centerline of the bottom portion of the positioning mechanism 1114A by a distance (d₁−d₂)/2 (see FIG. 8) to allow the auxiliary device to be mounted on a variety of weapons.

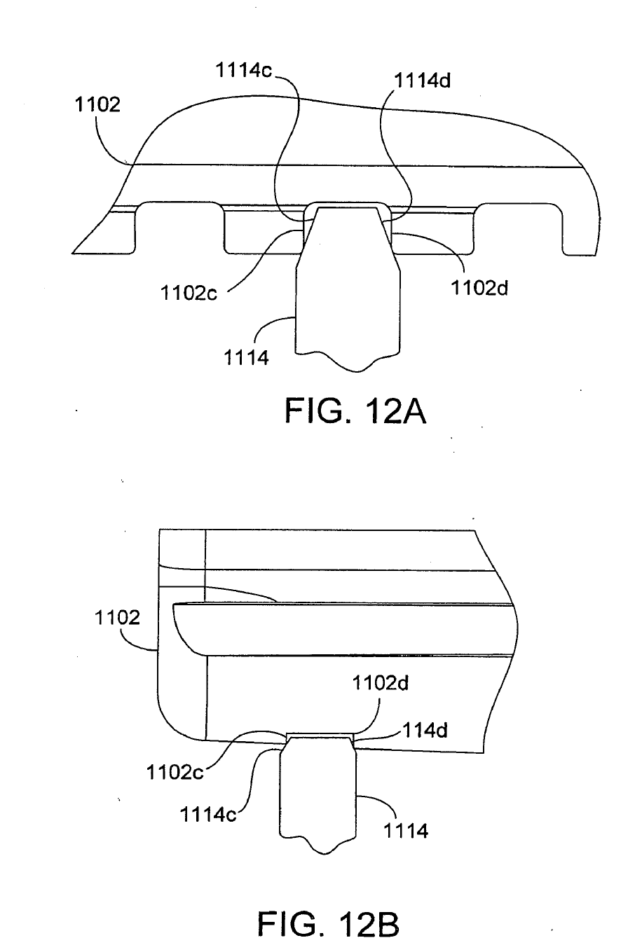

Referring to FIG. 11B, in an alternative embodiment, a positioning mechanism 1114B can be substituted for positioning mechanism 1114 to assist in preventing movement of the auxiliary device along the longitudinal axis of the rail 1102. In this embodiment, positioning mechanism 1114B may include one or more pins. Positioning mechanism 1114B may be biased by one or more springs 1116 to move the positioning mechanism in a direction normal to the top surface of the housing for engagement into a cooperating holes for receiving the pins. The profile of the positioning mechanism 1114, 1114A may take a variety of shapes including, but not limited to, a square edge and a beveled edge. As shown in FIGS. 12A and 12B the height and width of the transverse slot may vary from weapon to weapon. FIG. 12A is a side view of the positioning mechanism 1114 adjacent a MIL-STD-1913 slot 1102C and FIG. 12B is a side view of the positioning member 1114 adjacent a “Weaver” slot 1102D. As shown, the '1913 specification slot is 0.206 wide by 0.118 deep and the “Weaver” slot is typically 0.158 wide by 0.079 deep. The springs 1116 may bias the positioning member 1114, 1114A upward into the slot. With the '1913 specification slot and with the “Weaver” slot, a beveled edge 1114B, 1114C may contact vertical edges 1102C, 1102D of the rail 1102.

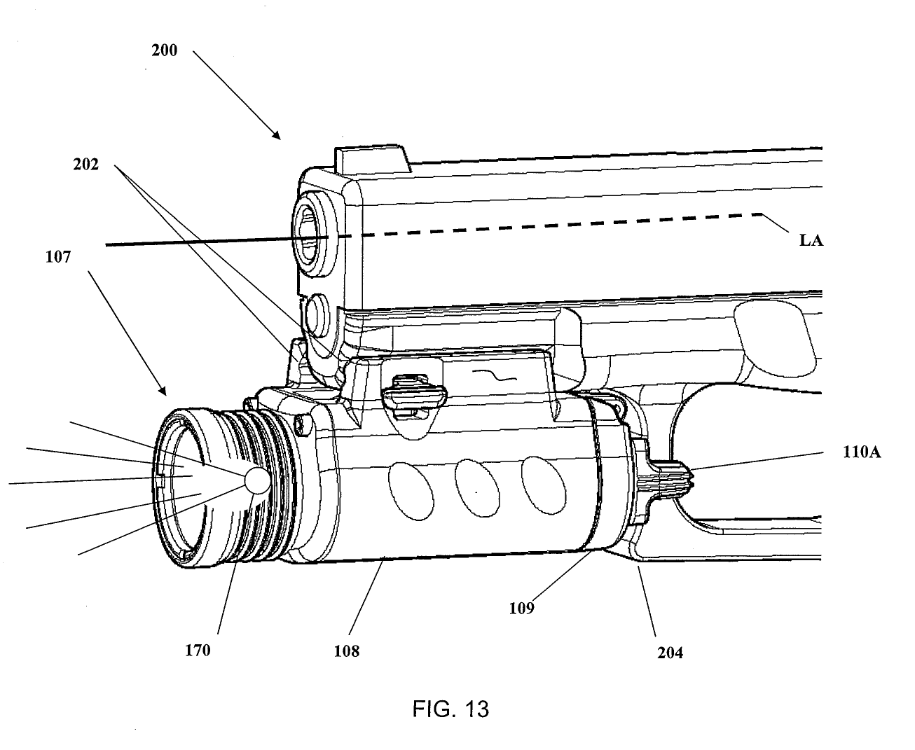

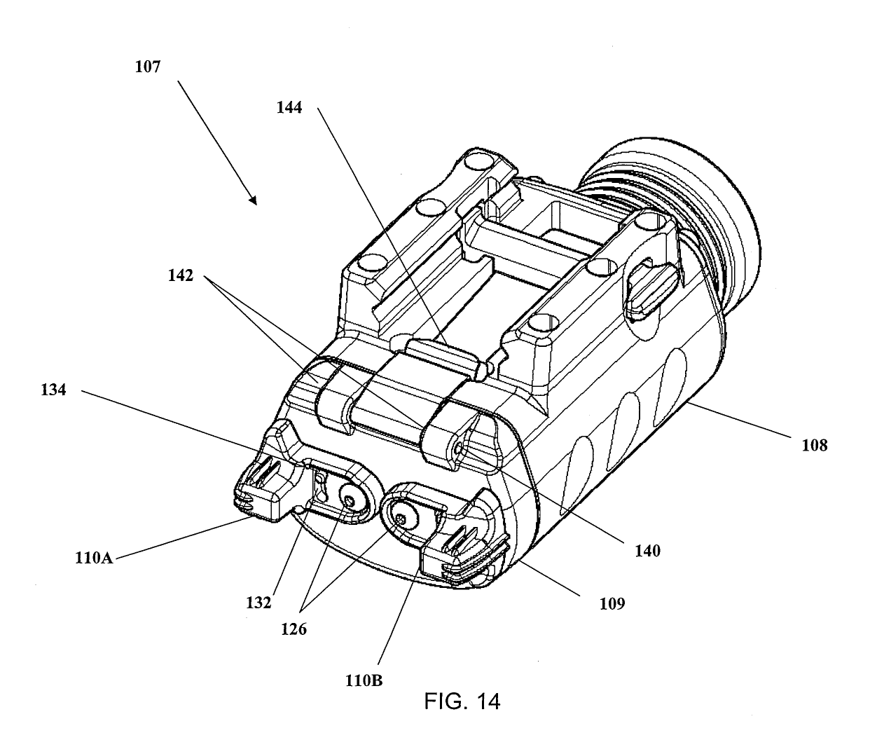

With reference to FIGS. 13 and 14, there is depicted a tactical illuminator 107 consistent with one embodiment of the invention mountable to a weapon 200. For convenience, the description that follows describes the tactical illuminator as a device generally used to cast light upon a target area or a portion thereof. The light may extend outwardly from a first end of the tactical illuminator 107 from a light emitter 170 and be generally aligned parallel with a longitudinal axis LA of the weapon 200. The light may illuminate a large area (e.g. a flashlight) or may be concentrated on a small area (e.g. laser pointer).

The weapon 200 may be a handgun (as shown), a long gun, or shotgun. A set of rails 202 may be disposed in an area forward of a trigger guard 204 extending generally parallel to the longitudinal axis LA of the weapon 200. The tactical illuminator 107 may be coupled to rails 202 in a variety of different ways. For example, the tactical illuminator may utilize the spring-biased mechanism disclosed in issued U.S. Pat. No. 6,574,901, or a conventional rail or trigger guard clamping mechanism.

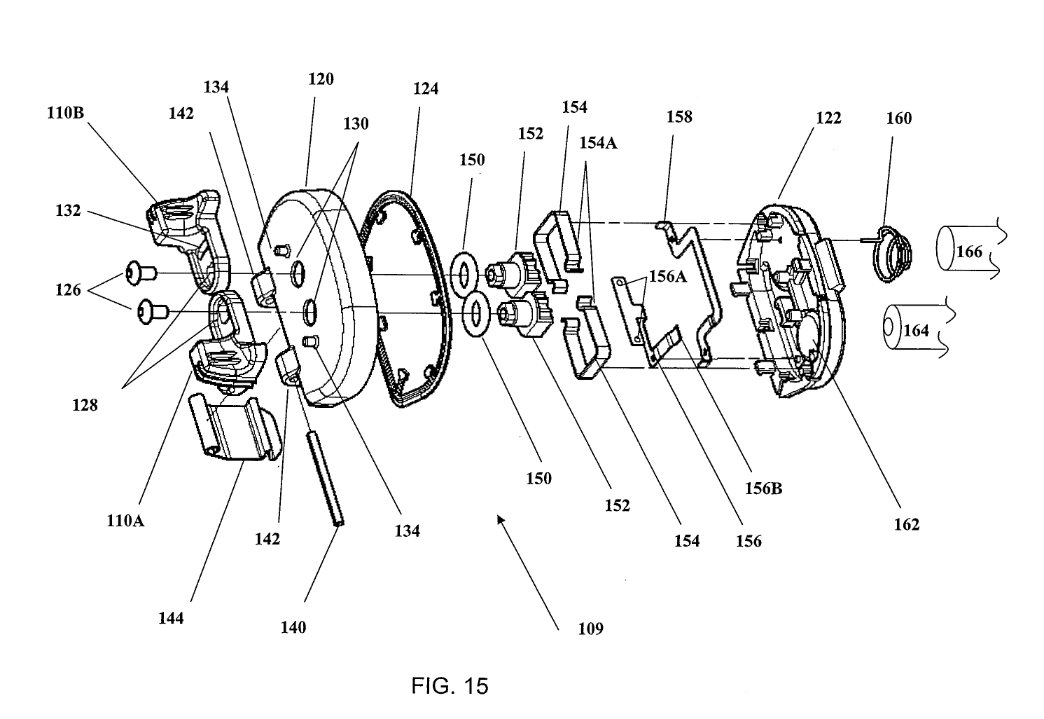

One or more actuators for controlling the on/off status of the light emitter 170 may extend outwardly from a second end of the tactical illuminator 107. A first actuator 110A may be spaced from a second actuator 110B (see FIG. 15) by a distance sufficient to allow the trigger guard 204 to extend therebetween. The actuators may be part of a tail cap assembly 109 that may be coupled to the housing 108 with a retainer 144. The retainer 144 may be secured to bosses 142 in the tail cap assembly 109 by a retainer pin 140 that may be rotatable about an axis perpendicular to the longitudinal axis of the housing 108. Alternatively, a retainer may be secured to the housing by a retainer pin.

FIG. 15 is an exploded perspective view of a tail cap assembly consistent with one embodiment of the invention. A first housing portion 120 and a second housing portion 122 may be coupled together with a gasket 124 and O rings 150 to form a water-tight tail cap assembly 109. First actuator 110A and second actuator 110B may be pivotably coupled to the first housing portion 120 by fasteners 126 extending through openings 128 in the first and second actuators 110A, 110B and openings 130 in the first housing portion 120. The first housing portion 120 may have protrusions 134 that extend through openings 132 in the first and second actuators 110A, 110B to limit the travel of the first and second actuators 110A, 110B.

First and second actuators 110A, 110B may be coupled to cam members 152 to urge portions 154A of conductors 154 into electrical contact with portions 156A of electrical conductor 156. The cam members 152 may have cammed surfaces on opposing sides to provide momentary and constant-on operation and provide tactile feel to actuators 110A, 110B. The end portion 156B of electrical conductor 156 may extend through an opening 162 in second housing portion 122 to provide an electrical connection to a first battery 164 disposed in the housing 108. Electrical conductor 158 may provide an electrical connection between conductors 154 and contact 160, which in turn provide an electrical connection to a second battery 166 disposed in the housing 108.

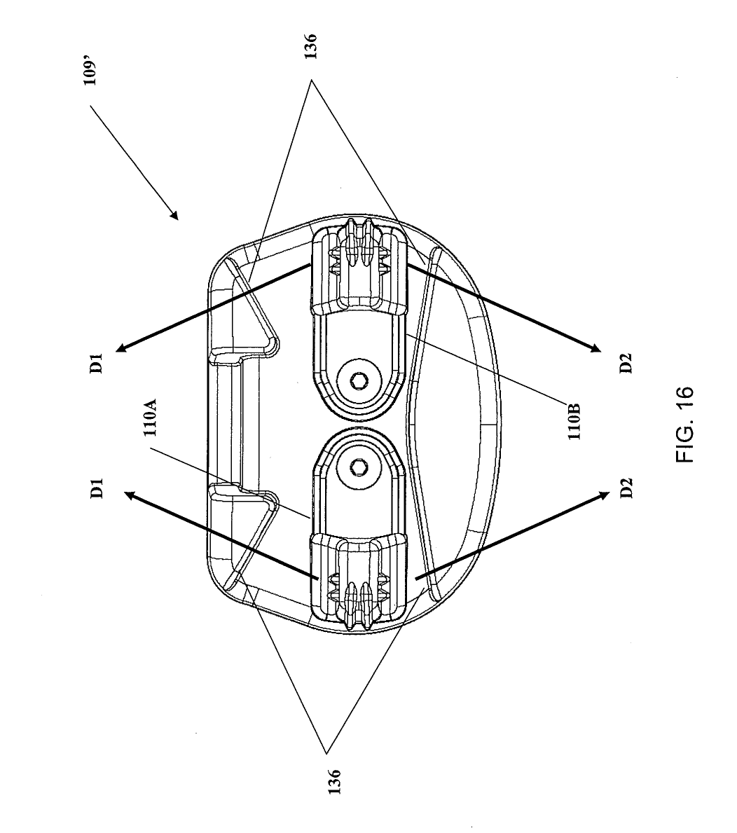

FIG. 16 is a rear view of a tap cap assembly 109′ consistent with a second embodiment of the invention. The rear tail cap assembly 109′ may have protrusions 136 for limiting travel of the first and second actuators 110A, 110B.

It has been discovered that it is easier to train a peace officer if a tactical illuminator actuator(s) works the same, regardless of which hand the weapon is in. FIGS. 15 and 16 show that the first actuator 110A may be moveable in a first general direction D1 (upward, when the weapon is operated in its typical orientation, i.e. the trigger guard under the barrel) to cause the light emitter to turn on and stay on and moveable in a second general direction D2 (downward) to cause the light emitter to stay on as long as the actuator is actuated and turn off when released. Second actuator 110B may be moveable in the first general direction D1 to cause the light emitter to turn on and stay on and moveable in the second general direction D2 to cause the light emitter to turn on as long as the actuator is actuated and turn off when released. Clockwise rotation of the first actuator 110A may cause the light emitter 170 to turn on and stay on and counterclockwise rotation may cause the light emitter 170 to turn on as long as the actuator 110A is actuated. Counterclockwise rotation of the second actuator 110B may cause the light emitter 170 to turn on and stay on and clockwise rotation may cause the light emitter 170 to stay on as long as the actuator 110B is actuated. The correlation between the clockwise/counterclockwise movement of the actuators 110A, 110B and whether the light emitter 170 turns on and stays on may be changed without departing from the invention.

Although several embodiments of the present invention have been described in detail herein, the invention is not limited hereto. It will be appreciated by those having ordinary skill in the art that various modifications can be made without materially departing from the novel and advantageous teachings of the invention. Accordingly, the embodiments disclosed herein are by way of example. It is to be understood that the cope of the invention is not limited thereby.

We claim:

1. A tail cap assembly for use on a weapon-mountable flashlight, comprising:
a first housing portion coupled to a second housing portion with a gasket to form a watertight cavity therein;
a first contact coupled to the second housing;
a second contact coupled to the second housing;
a first movable actuator, the first actuator having a protuberance that can be manipulated by a user to cause the first actuator to move in a first general direction or a second general direction; and
a second movable actuator, the second actuator having a protuberance that can be manipulated by a user to cause the second actuator to move in the first general direction or the second general direction, the first protuberance being spaced from the second protuberance by a distance sufficient to allow a trigger guard of a weapon to extend therebetween, the first actuator moveable in the first general direction independent of the second actuator to cause a light emitter coupleable to a battery to turn on and stay on and moveable in the second general direction independent of the second actuator to cause the light emitter to turn on as long as the actuator is actuated by a user, and turn off when released, and the second actuator moveable in the first general direction independent of the first actuator to cause the light emitter to turn on and stay on and moveable in the second general direction independent of the first actuator to cause the light emitter to turn on as long as the actuator is actuated by the user, and turn off when released, movement of the first or second actuator in either direction causing the first contact to be shorted to the second contact.

2. The tail cap assembly of claim 1, wherein the first movable actuator is rotatable about a first axis, the protuberance of the first actuator operable by a user to cause the first actuator to rotate clockwise or counterclockwise.

3. The tail cap assembly of claim 2; wherein the second movable actuator is rotatable about a second axis parallel to and spaced from the first axis, the protuberance of the second actuator operable by a user to cause the second actuator to rotate clockwise or counterclockwise.

4. The tail cap assembly of claim 2, wherein the first axis is parallel to a barrel of the weapon.

5. The tail cap assembly of claim 1, wherein the first actuator and the second actuator are pivotably coupled to the first housing portion by fasteners extending through openings in the first and second actuators and openings in the first housing portion.

6. The tail cap assembly of claim 1, wherein the first housing portion has a protrusion that limits travel of the first actuator.

7. The tail cap assembly of claim 6, wherein the protrusion extends through an opening in the first actuator to limit the travel of the first actuator.

8. The tail cap assembly of claim 5, wherein the first actuator is coupled to a cam member to urge a portion of a first conductor into electrical contact with a portion of a second conductor to cause the first contact to be shorted to the second contact.

9. The tail cap assembly of claim 8, wherein the cam member has cammed surfaces on opposing sides that provide shorting of the first and second contacts when the first actuator is rotated.

10. The tail cap assembly of claim 9, wherein the cammed surfaces provide tactile feel to the user.

11. The tail cap assembly of claim 1, wherein the first contact is coupled to the second housing to align with a first battery and the second contact is coupled to the second housing and spaced from the first contact so as to align with a second juxtaposed battery.

12. The tail cap assembly of claim 8, wherein a portion of a first contact and a portion of a second contact extend through an opening in the second housing and are coupled to the first conductor and the second conductor, respectively.

13. The tail cap assembly of claim 12, wherein the first contact is a compressible spring.

14. The tail cap assembly of claim 1, further comprising a retainer rotatable about the first housing portion.

15. The tail cap assembly of claim 1, wherein the first general direction is upward and the second and opposite general direction is downward when the flashlight is mounted to the weapon and the weapon is held with a barrel of the weapon above the trigger guard.

16. The tail cap assembly of claim 1, wherein the first actuator is rotatable clockwise to cause the light emitter to turn on and stay on and rotatable counterclockwise to cause the light emitter to turn on as long as the actuator is actuated and off when released, and the second actuator is rotatable counterclockwise to cause the light emitter to turn on and stay on and rotatable clockwise to cause the light emitter to turn on as long as the actuator is actuated and off when released.

17. The tail cap assembly of claim 1, wherein the first actuator and second actuator move in a plane generally perpendicular to an axis parallel to a barrel of the weapon when the flashlight is mounted to the weapon.
